(19) United States
(12) Patent Application Publication
(10) Pub. No.: US 2024/0370889 A1
(43) Pub. Date: Nov. 7, 2024

(54) SYSTEM AND METHOD FOR CUMULATIVE SERIES EVENT PREDICTION

(71) Applicant: Better Collective USA, Inc., New York, NY (US)

(72) Inventors: Daniel Back, Brentwood, TN (US); James Riley Bryant, Nashville, TN (US); Christopher Gimino, Fairless Hills, PA (US)

(21) Appl. No.: 18/650,611

(22) Filed: Apr. 30, 2024

Related U.S. Application Data
(60) Provisional application No. 63/499,361, filed on May 1, 2023.

(51) Int. Cl. G06Q 30/0202; G06Q 50/34

(52) U.S. Cl. CPC G06Q 30/0202; G06Q 50/34

(57) ABSTRACT

Systems, methods, and computer-readable storage media for cumulative series event prediction, and more specifically to calculating the likelihood of a single downstream event by using multiple simulations. A system can receive sports data and generate, using the sports data, simulated events data. The system can also execute a simulated market participant data model, resulting in a simulated markets model. The system can then execute, in parallel, the simulated markets model and an event simulation/analysis, and output both the event prediction and predicted betting markets to a user.

### CROSS-REFERENCE

This application claims priority to U.S. provisional patent application No. 63/499,361, filed May 1, 2023, the contents of which are incorporated herein in their entirety.

### BACKGROUND

### 1. Technical Field

The present disclosure relates to cumulative series event prediction, and more specifically to calculating the likelihood of a single downstream event by using multiple simulations.

### 2. Introduction

Simulations involving a cumulative series of possible events represents a computationally intense problem.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, sports data; generating, by executing a predictive event outcomes model using at least one processor of the computer system, simulated events data, wherein input to the predictive event outcomes model comprises the sports data; executing, via the at least one processor, a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

A system configured to perform the concepts disclosed herein can include: at least one processor; a non-transitory computer-readable storage medium having instructions stored which, when executed by the at least one processor, cause the at least one processor to perform operations comprising: receiving sports data; generating, by executing a predictive event outcomes model, simulated events data, wherein input to the predictive event outcomes model comprises the sports data; executing a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

A non-transitory computer-readable storage medium configured as disclosed herein can have instructions stored which, when executed by at least one processor, cause the at least one processor to perform operations which include: receiving sports data; generating, by executing a predictive event outcomes model, simulated events data, wherein input to the predictive event outcomes model comprises the sports data; executing a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

A method for performing the concepts disclosed herein can include: receiving, at a computer system, sports data; generating, by executing a predictive event outcomes model using at least one processor of the computer system, simulated events data, wherein input to the predictive event outcomes model comprises the sports data; executing, via the at least one processor, a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

A system configured to perform the concepts disclosed herein can include: at least one processor; a non-transitory computer-readable storage medium having instructions stored which, when executed by the at least one processor, cause the at least one processor to perform operations comprising: receiving sports data; generating, by executing a predictive event outcomes model, simulated events data, wherein input to the predictive event outcomes model comprises the sports data; executing a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

A non-transitory computer-readable storage medium configured as disclosed herein can have instructions stored which, when executed by at least one processor, cause the at least one processor to perform operations which include: receiving sports data; generating, by executing a predictive event outcomes model, simulated events data, wherein input to the predictive event outcomes model comprises the sports data; executing a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

### BRIEF DESCRIPTION OF THE DRAWINGS

FIG. 1 illustrates an example process for identifying and filtering cumulative series events;

FIG. 2 illustrates an example of system integration and processing;

FIG. 3 illustrates an example of baseball game simulations being modeled using the disclosed system;

FIG. 4 illustrates an example method embodiment; and

FIG. 5 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Systems configured as disclosed herein can simulate a cumulative series of possible events to calculate the likelihood of a single downstream event. By parsing the outcomes of multiple simulations, users can match simulation data to different outcomes, resulting in a more informed prediction of expected outcome. For example, by executing multiple layers of simulations, the system can solve for a scenario such as: “If “X” happens, how likely is “Y”?”, where X and Y can be related or unrelated events.

To do so, the system can run many (e.g., thousands or millions) of simulations of possible events to predict performance using factors/variables provided by the user. These factors/variables can vary depending upon the events being evaluated. The resulting projections can then be matched against historical data, current circumstances, and/or known estimates, resulting in correlations between the factors/variable, projections, and known data. For example, if simulating the value of a stock undergoing an event (for example, a drop in revenue), the outcome of the combined simulations can be paired to the current stock value. Likewise, if simulating the outcome of a sporting event, the outcome of the combined simulations can be paired to current odds for that sporting event offered by a sportsbook. Continuing with the sporting event simulation, if the system is being used to predict statistics in a sporting event, the system can rely on probability inputs across a spectrum of desired outputs. In the example of basketball, a full game can be modeled on the results of each possession. Within each possession, probability inputs can be assigned and selected at random while adhering to a set of constraints. The constraints can serve to mimic the behavior and experience of a basketball game being played. For example, a single possession can only end in one of three ways: a turnover, a shot, or a trip to the foul line. This constraint governs the selection of the events, while other constrains can govern which players are involved in the action. At the end of each simulated game, statistics are tabulated and stored as a trial. This simulation process repeats as many times as necessary to gain adequate sample. This process is repeatable in other scenarios, with statistics being iteratively generated for each segment of a parlay, with the ultimate predictions being made using the sums of those segment predictions.

That is, the system may make a series of predictions P for an event, situation, or circumstance multiple times. Iteration “A” uses probabilities individual actions to develop a total probability for iteration A, PA (That is, (P_{A1}+P_{A2}+P_{A3} . . . =PA), where P_{A1}, P_{A2}, and P_{A3} reflect the probabilities of a single component, and PA reflects the combined probability). Similar iterations are done to develop PB. Pc . . . to whatever number of iterations is desired. The system can then average, identify the mean, or otherwise predict the overall probability based on the probabilities of the previous simulations and generated probabilities.

Other exemplary areas where the system can create predictions can include politics, weather, and box office receipts.

While systems configured as disclosed herein can make such predictions for a single event, systems configured as disclosed herein can also generate the likelihood of outcomes when more than one event is simulated (i.e., parlaying the events together). By executing the simulations and combining them together, the system can show an implied percentage and odds of occurrence on the parlay based on the simulations. This is useful to users in identifying which possible chain of events create a highest likelihood of occurring, which events create (in the case of stocks or wagering) a highest possible payout, which events are least likely to occur, etc.

While parlay calculators for betting are common and show users what price multiple bets will pay out when stacked up together, such tools provide no context about the expected performance of the bet compared to the odds. By contrast, the system disclosed herein provides this context information to users. Non-limiting, exemplary context information can include an indication that action “X” happens a certain percentage of the time, and the live odds of “X” and “Y” and “Z” happening (i.e., a parlay) could be displayed. The system can also display arbitrage opportunities, where the odds calculated by the system for a parlay event may differ from the odds being offered by other platforms.

The system disclosed herein provides simulations and pairs markets to those simulations. For example, with stocks, the simulations can be aligned to options trading (e.g., calls/puts) which identify future prices and list current prices for those options. Likewise, with sporting events, the simulations can be aligned to current odds being generated by one or more sportsbooks. Pairing can be technically difficult to a lack of availability of data feeds and how non-standardized such data feeds often are. Moreover, parsing the data feeds can be rigorous as each data feed may have a unique format.

The system disclosed herein can execute multiple models in parallel. For example, the system can be executing a first model which (as data is being about an event), predicts how that event is likely to turn out. At the same time, the system is executing a second model which predicts how markets and/or other people will react to the event. These simultaneous, parallel models can then be used to identify a user of opportunities. For example, in a sports example, the system can be modeling (using a first model) a specific game, while at the same time (using a second model) modeling how betting markets are likely to respond to the game. Preferably, the first model and the second model do not communicate with one another during the modeling processes. Then, the results of each model can be presented to the user. In some configurations, specific opportunities can be identified. Continuing with the game example, the system may determine that when team A scores, the market is likely to increase the odds that team A will win (and team B will lose). However, if the model still identifies that team B is likely to win despite team A scoring, the system may flag such an occurrence as a betting opportunity.

The system described herein can also be used for the purposes of probability assignment in fantasy sports and betting. In order to make such predictions, the system collects “raw data” (i.e., data which has not been manipulated) about a given event. For a sporting example, the sports data information can be sourced in a raw format from accredited official sources (e.g., directly from the sports league, directly from a reporter, directly from game officials, etc.). Such data can be granular detail from the event (e.g., “Play by play”). The data received can be stored within a database, and may require normalization, organization, and/or cleaning for re-use. An Application Programming Interface (API) may be established with the database to allow recall of information from the database. When making predictions of future phases, the system can use the historical data stored within the database. Real-time information (i.e., information received with delays only for transfer of data through the Internet or another network) about the status of upcoming events can be a key component of data collection. In the sports example, the data can be sourced from a combination of third party data providers (e.g., Sportsbooks, sports leagues) and internal system operators. In a stock market example, the data can be sourced directly from an exchange or news organizations with access to primary resources (e.g., BLOOMBERG®). The real-time market information should also be collected and stored.

For analysis of an event, consider the following example of a sports event simulation for purposes of probability assignment in fantasy sports and betting. Using an API, the system recalls raw sports data from a server. Using mathematical modeling, the system assembles and calculates a model (also known as a “single event analysis tool”) for predicting sports outcomes. The system can breakdown elements and events that occur in each sport type (e.g., for American football, the system can identify “first downs,” “touchdowns,” “extra points,” “holding,” etc.). The system can then establish, (using combinations of linear, machine learning, Artificial Intelligence (AI; such as, but not limited to neural networks trained on the data stored in the database), or other modeling technique)) the underlying probability of each possible sub-event and action. For example, in baseball, the system, executing the model, can predict the outcome of a single batter plate appearance.

The system can then apply rules that govern each event type to create a simulation of an individual game, using the prior outcomes as necessary to predict the next outcome. In some cases, these rules can be built into the model (e.g., the rulebook for a given sport, government regulations for how an event should occur, etc.). In other configurations, the rules can be developed by the model as part of a training process (e.g., the neural network can identify rules which, upon detecting an event, are automatically triggered). The system can then assemble the results of a game in such a way that those results can be identified as unique and used for additional processing in later steps.

Recognizing that computer systems change over time, at present the system preferably repeats the prediction process a minimum of 5000 times, but with the understanding that more simulated “trials” are superior for accuracy. 10,000 is often sufficient. 100,000 or more is ideal. These simulations are similar to a Monte Carlo simulation, where many simulations are made and compared to identify the probability of a given outcome. In order to achieve the above number of trials with adequate speed, parallel computer system processing must be deployed. Preferably, using computer code techniques, the event simulation model is deployed simultaneously to a series of computer platforms in a cloud computing environment. Again recognizing that computer capabilities change over time, at present the system requires at least forty (40) distinct computer platforms. The desired number of trials are split equally among the different platforms. The benefits are to be as reactive as possible in real time to new information that impacts the realism of the simulation, such as event participant availability/injury status in sports, new data in the market, etc. The system can then store the outcomes/probabilities of each individual event in a centralized storage location. These outcomes and probabilities can then be used for end user facing interface programs.

Preferably, each individual event has its own dedicated simulation model being executed across multiple computer platforms. The system establishes a trigger point (or multiple trigger points) for when the simulation model should be executed. Once executed, the simulation model is executed across the multiple computer platforms simultaneously, in parallel, and the system combines the outcomes/probabilities into a single source of data associated with the event. That single source of data can then be communicated to a user as odds, likelihood of an event occurring, an arbitrage opportunity, etc.

The simulated event analysis tool (or model) can be used to assign probabilities to one or more events associated with a specific event. In the context of fantasy sports or betting, the system can use information a single event or multiple related events within a sports category (i.e., the system can predict a single game or a series of games, a single “at bat” by a baseball player or an entire game). To do so, the system can establish an API such that files associated with the event can be recalled from the server and used for additional applications. The data being recalled can represent the cumulative probability of various event occurrences within a series of past events. Using that data, the system can predict probabilities for future events. For example, in the case of stocks, the data can be used to assign probability on the performance of the stock over a year, or for performance of the stock over specific quarters. In a sporting example, the data can be used to establish a range of individual player outcomes, outcomes of games, or specific portions of the game (e.g., first half performance, second half performance). In yet another sporting example, individual player statistical outcomes can be compared to betting markets, and probability can be considered to evaluate the likelihood that a sports betting wager will be successful.

In parallel with the event simulation, the system also models market participation, predicting how the market (i.e., other users or people) will react to an event. Consider the example of the system being used to evaluate daily fantasy sports entries. In this example, the model establishes a simulated field of participants in a simulated daily fantasy sports contest. A contest is identified for evaluation and a trigger is sent to start the process. First, the system generates an API call to acquire contest information (e.g., the raw data discussed above) from a database, from primary resources, and/or a combination thereof. Daily fantasy contest information can include real sports games under consideration, the rules of the contest, the payouts and prize of the contest, and the player pool information of the contest. An additional API call can be made to the simulated events model (or a server sending the model out to be executed by multiple cloud platforms) to obtain the requisite event data for each sporting event associated with the contest at hand.

Once that data is acquired, the first step in simulating a field of market participants is to identify historical behaviors and apply them. This can include: A typical number of participants per contest; Trends in how the participants make decisions on sporting event player options; Trends on how the participants utilize available “salary cap”/adhere to the limits of the market conditions; How the participants consider correlated outcomes within their selections; How the participants consider the behavior of their opponents when making choices; and so forth. This information can then be used to setup a suite of “settings” and rules for an optimizer to use when creating a simulated field of participants. It is noted that the optimizer is not the only agent of shaping the field of participants. In some configurations, once all lineups are created, the system can read the aggregated fantasy points value and select (using a series of tiered groupings), at random, smaller subsets of the lineups for use. As needed, this process may become even more complex and precise to shape the field of participants using other details. The goal is for the system (via the simulated markets model) to use aggregate collection of entries to mirror typical real life fantasy contests in their aggregate heuristics.

With the settings (which are intended to help mirror heuristics), the system executes parallel processes (in the cloud) the parallel event simulations disclosed above. Preferably, the system executes a simulation using minimum of fifty thousand (50,000) possible contest participants using the event simulations data generated using the event simulator. An optimization engine uses the settings to create a participant lineup based on the optimal solution that meets conditions identified by a user. Preferably, this happens iteratively on a loop through each simulated game, which is paired with a unique individual game from all real-life sporting events available to the contest. This collection forms a simulated trial for a single simulated contest result. This is repeated for all available simulated trials, and processed in the cloud simultaneously, across the available cloud computing platforms as previously discussed.

Once a large set of participants is created by the system, the system can also create other smaller subsets of participants based on their traits. These smaller subsets can be used to vary evaluations, and vary the participants. For example, not all contests are the same, and the context of doing this is to better mimic the participants in smaller and/or more specific contests. For example, if betting on a regional game, or purchasing a niche stock, the audience (and therefore market participants) may be very small/specialized. Likewise, the aggregate/total body of participants created by the generator can also be cropped and/or molded to better fit the heuristics of a simulated contest field according to desired metrics.

From these participants, the system can reapply the results each of the simulated trials to each of the participant lineups. A single simulated contest for a fantasy sports example looks like this: Step 1: Apply fantasy points from a first trial to all participant lineups. Step 2: Tabulate the total fantasy points per lineup and rank the participant lineups. Step 3: Import the contest payout details and apply a simulated prize amount to each participant. Step 4: Repeat for all available trials. These steps require significant computing resources, and is once again performed using a large number (40 minimum) of computer servers or platforms operating simultaneously. At this point, the system has a larger collection of simulated contests, and repeats this action for all simulated contest fields. That is, if there is a “Large Field”, “Small Field”, and “Smallest Field”, the system can repeat this for all three fields of potential participants. The system can then aggregate the results and determine the expected return on investment for each simulated contest entrant in the respective field.

In order for a user to make decisions based on the simulated event, consider the reasons the user may elect to choose a given entry for their own, rather than relying on the system's evaluation: (1) They may prefer to enter lineups that did well (based on ROI) in a simulated market model; (2) They may prefer to enter lineups with a high mean fantasy points performance expectation; (3) They may prefer to enter lineups with a high frequency of top 1% finishes or “in the money” finishes; (4) They may prefer to enter lineups in which the player selections correlate with each other in any given trial; (5) They may prefer to enter lineups in which the geometric mean optimal rate of all selections in the lineup is high. The system, to address some of these concerns, can generate scores (e.g., 0-99) on these metrics, allowing the user to weight what matters to them, and query for results based on their preferences. Such weights are referred to as “Simulation Weight”, “Projection Weight”, “Ownership Weight”, “Upside Weight”, and “Correlation Weight”.

The simulation weight can modify how the single event prediction is ranked; the projection weight can modify how the predicted betting markets are ranked; the upside weight can modify how a projected upside is ranked; and the correlation weight can modify how the at least one correlation effects the simulated markets model. For example, The simulation weight 0-99 score can be based on the simulated markets return on investment (ROI). The projection weight 0-99 score can be based on a lineup mean fantasy points projection. The upside weight can be based on a frequency of top tier finishes and assigned 0-99 score based on that frequency. An ownership weight: 0-99 score based on how often (geometric mean) players in lineup appeared as optimal. The correlation weight 0-99 score can be based on setting criteria for how closely the players in the lineup expect to correlate with each other in their outcomes.

In addition to these ratings, the system can also compile details about the simulations as a whole for users to examine on a user interface. Non-limiting examples of such information can include, for a fantasy sports example: the simulated fantasy points cash line distribution, the simulated winning score line distribution, a comparison of the optimal lineup appearance rate to daily fantasy sports projected ownership, etc.

The system described herein is designed to simplify contest participation for a user by reducing the number of choices and inputs they need to make in a market associated with events, in which other participants can affect the market through purchases or selections. In an example, the user can determine how many entries (e.g., possible portfolios, lineups, or other configurations) they would like to see generated. The user can also select how wide (e.g., how many different lineups, options, etc. to check) within the available result set to search, in which a narrow range would be focusing on a higher total model score (i.e., higher projected return or value), and a wide range would be less restrictive of model score. The user can also select a contest field, which determines which subset of lineup entries to consider. In addition, the user can filter out selectable items (e.g., players (if, for example, using the system for fantasy sports), and if applicable, teams, stocks, or other options) from their results, or force a selectable item to appear in all returns. Upon selecting desired options on a user interface, the user can send a query from their device (e.g., computer, smartphone, or other mobile computing device) to the system, and the system can return options for the user's consideration (e.g., games, lineups, stocks, or other selectable items as needed). This query (containing one or more of the options listed above) is sent from the user's device to the system (e.g., a web server) for processing.

When desired, the user can also provide weights which can be included in the query. Non-limiting exemplary weights can include: “Simulation Weight”, “Projection Weight”, “Ownership Weight”, “Upside Weight”, and “Correlation Weight”. Such weights can, for example, be assigned numerical weights, which can act as a multiplier on how the system uses a given aspect in providing potential results. Using the weights, the system can identify possible lineups, games, stocks, or other selectable events in which the user might be interested, weighted according to the user's preferences. In this manner, the system provides the user a simple mechanism for identifying selectable entries that match their own personal preferences.

User decisions can be made on the metrics, sorting tool, and evaluations provided. In practice, many users have multiple lineups to form a fleet of entries. For example, a daily fantasy sports player may have many “teams” or “leagues” in which they play fantasy sports. A stock trader may have multiple accounts or portfolios. Preferably, the system provides details to the user to monitor their “exposure” to different players, teams, and lineup construction types if playing fantasy sports. If using the system for stocks, the system can provide exposure to a common stock, market, or field using the same principles. All of this is based on a series of simulations to power decision metrics.

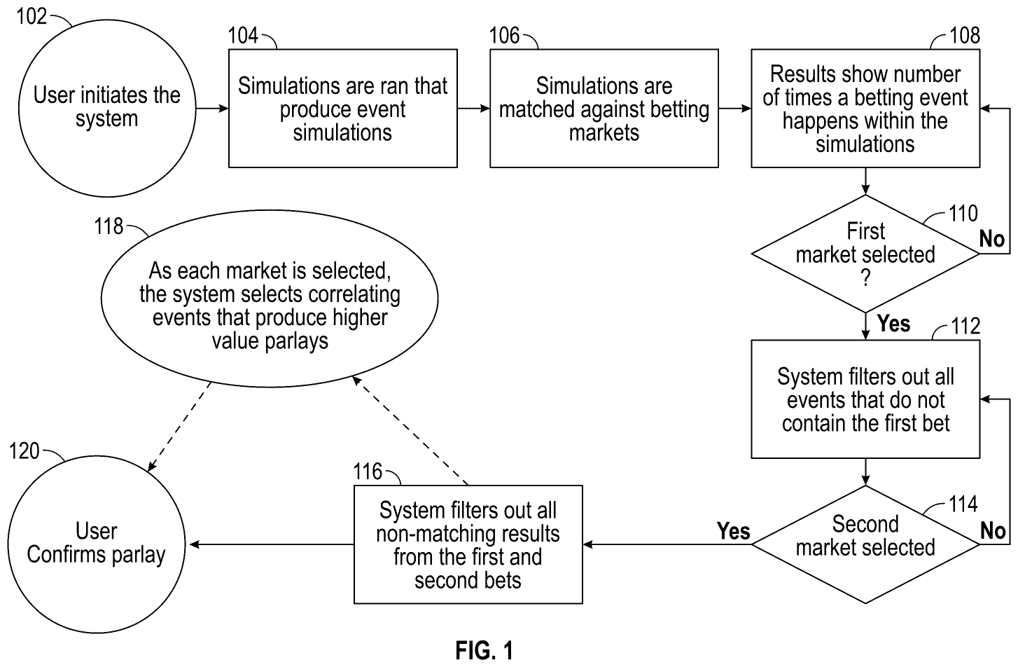

FIG. 1 illustrates an example process for identifying and filtering cumulative series events. As illustrated, the user initiates the system 102, and simulations are generated which each produce event likelihoods 104. For example, the system can execute a number of simulations for a football game, and based on those simulations identify the likelihood that there will be a fumble, that a certain number of points will likely be scored, a likely point differential, a likelihood of a certain number of sacks, etc., such that each simulation generates values for those different likelihoods. If the system were simulating stocks, the system could execute a number of simulations which might affect the stock value, and determine a likelihood of a certain increase in revenue, a decrease in profitability, a likelihood of a dividend, etc., such that for each simulation values associated with those likelihoods.

Based on those simulations, the system can match each simulation against the betting markets 106. For example, in the case of sports simulations, the system can align a given simulation (and its multiple event likelihoods) to odds provided by a sportsbook. In the case of finance or stocks, the system can align a given simulation (and its multiple event likelihoods) to option prices. The various results can then be aggregated together and displayed to the user, such that the user can be shown the number of times a given event is likely to occur across all of the simulations 108.

The user can then select a market 110 for a first bet (e.g., a specific sportsbook or an option seller), and the system can filter out all future events which do not rely on that first bet 112. From those filtered events, the system can select a second bet (e.g., a second market 114), which again results in filtering non-matching results 116. Preferably (though not required), the system identifies the events which, if they happen, will produce the highest possible returns for the user. If desired and available, the system can provide more than two cumulative series bets in forming the parlay, with the result being that each time a market is selected, the system selects correlating events that produce higher value parlays 118. The user can then confirm or finalize the parlay 120.

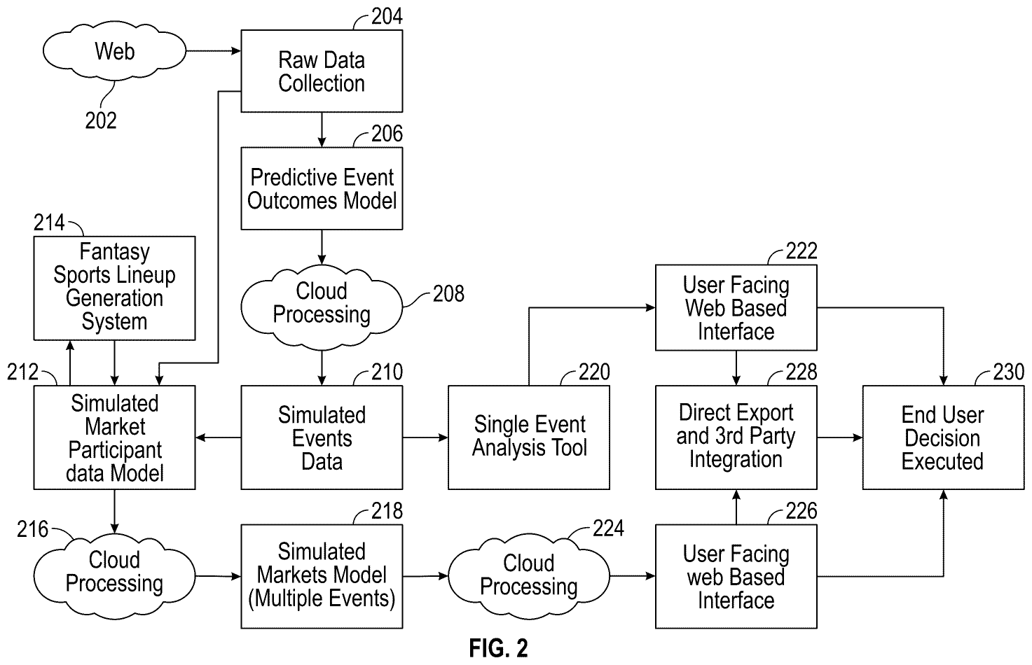

FIG. 2 illustrates an example of system integration and processing. In this example, the system collects raw data 204 from the web 202 (such as from databases, news sites, financial exchanges, sports leagues, etc.). This raw data 204 is used by a predictive event outcomes model 206 executed in a cloud processing 208 environment, where the predictive event outcomes model can perform probability assignment for events that can occur in a given market. The result is simulated events data 210, which is a combination of many event simulations. The system can use that simulated events data 210 to generate a single event analysis tool 220, where (for example) the simulated events data 210 can be used to by the single event analysis tool 220 with current (i.e., real-time) data to predict future outcomes. These outcomes can, for example, be output to a user facing web-based interface 222 (such as the user's phone if the system's output is viewed on a smartphone app, or a computer screen if viewed on a browser).

The simulated events data 210 can also be used to generate a simulated market participant data model 212, which emulates how various participants engage with a system. In the illustrated example, the simulated market participant data model 212 can use a combination of fantasy sports lineup generation 214 data, with the simulated events data 210, to understand how individual participants react in various situations. The result of the simulated market participant data model 212 processing (via cloud processing 216) the fantasy sports lineup generation 214 data and the simulated events data 210 is the simulated markets model 218, which can make multiple, serial event predictions (i.e., parlays). When the system executes (using cloud processing 224) the simulated markets model 218 using current and/or past data, the system can predict how the markets will react to a given scenario, then output those predictions to the user via a user facing web-based interface 226. In some configurations, this user facing web-based interface 226 can be the same as the other user facing web-based interface 222, such that the user is only looking at a single output of the system. Preferably, the single event analysis tool 220 and the simulated markets model 218 are executed simultaneously, in parallel, using cloud computing platforms. Where desired, the system can direct export and third party integration of the outputs 228, allowing for coordination with other platforms (e.g., Sportsbooks, financial exchanges, brokers, etc.). The end user can then make a decision, such as whether to buy shares, place a bet, select a fantasy sports lineup, and the system can execute that decision 230.

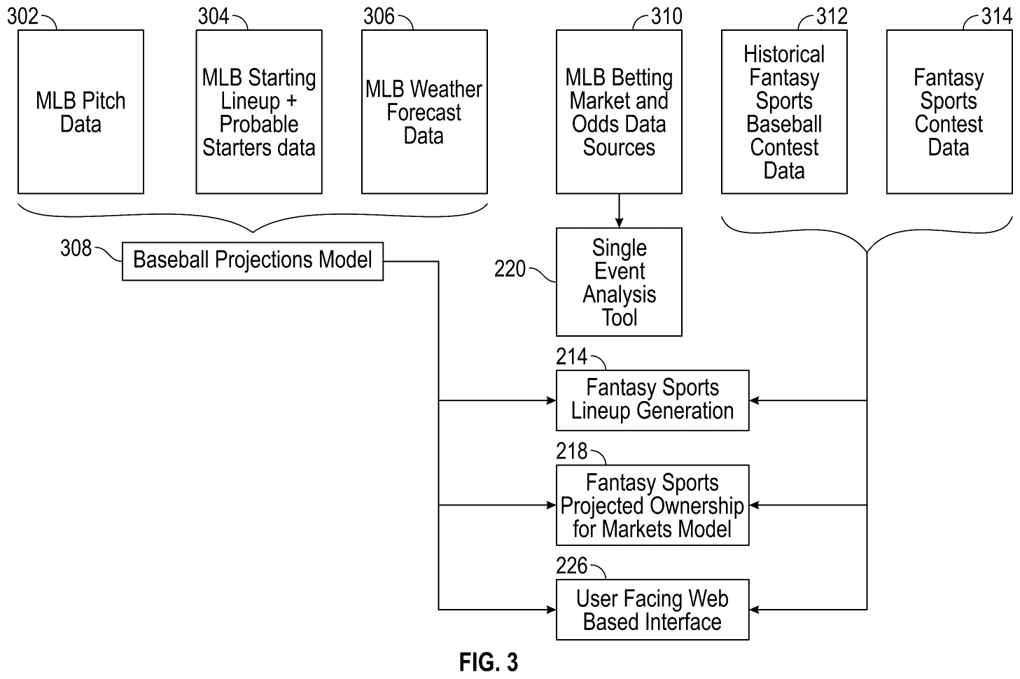

FIG. 3 illustrates an example of baseball game simulations being modeled using the disclosed system. In this example, the system receives raw data from one or more sources, such as MAJOR LEAGUE BASEBALL™ (MLB) pitch data 302, MLB starting lineup and probable starters data 304, and MLB weather forecast data 306. These data 302, 304, 306 can come from a single source, multiple sources, or any combination thereof. the system inputs these data 302, 304, 306 into a baseball projections model 308, which is a sport-specific version of the predictive event outcomes model 206 illustrated in FIG. 2. The indirect results of the baseball predictions model 308, following the systems outlines in FIG. 2, can include a predicted fantasy sports lineup generation 214, a fantasy sports projected ownership for markets model 218, and outputs to the user facing web-based interface 226. Included in the predicted fantasy sports lineup generation 214, the fantasy sports projected ownership for markets model 218, and the outputs to the user facing web-based interface 226 can be historical fantasy sports baseball contest data 312 and fantasy sports contest data 314. MLB betting market and odds data sources 310 can be used as part of the single event analysis tool 220, which is being executed in parallel with the baseball projections model 308 in this example.

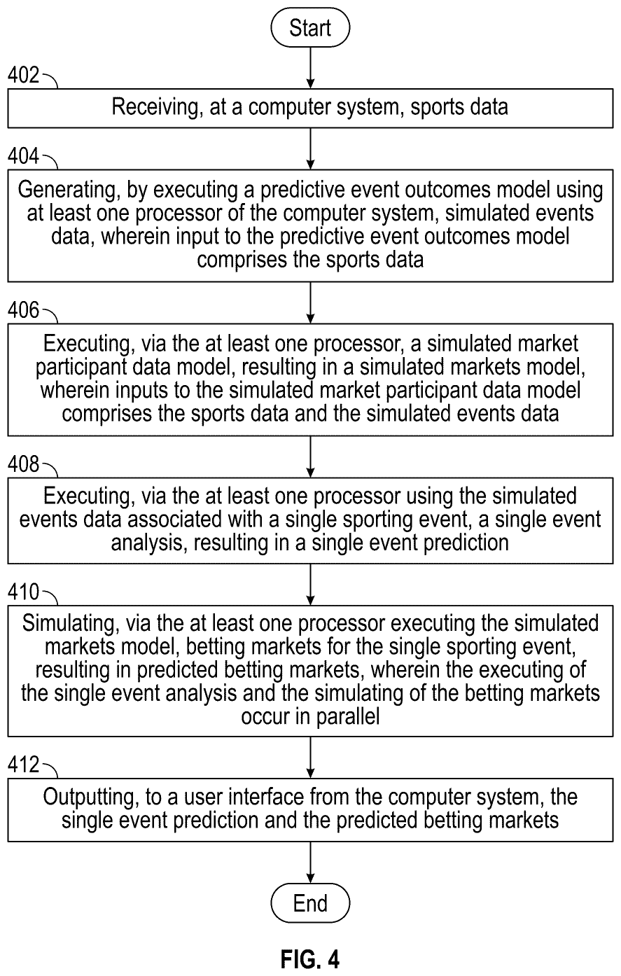

FIG. 4 illustrates an example method embodiment. As illustrated, the method can include: receiving, at a computer system, sports data (402), generating, by executing a predictive event outcomes model using at least one processor of the computer system, simulated events data, wherein input to the predictive event outcomes model comprises the sports data (404); executing, via the at least one processor, a simulated market participant data model, resulting in a simulated markets model, wherein inputs to the simulated market participant data model comprises the sports data and the simulated events data (406); executing, via the at least one processor using the simulated events data associated with a single sporting event, a single event analysis, resulting in a single event prediction; (408); simulating, via the at least one processor executing the simulated markets model, betting markets for the single sporting event, resulting in predicted betting markets, wherein the executing of the single event analysis and the simulating of the betting markets occur in parallel (410); and outputting, to a user interface from the computer system, the single event prediction and the predicted betting markets (412)

In some configurations, the computer system can be a cloud computing system. In such systems, the sports data can be periodically received while the single sporting event is ongoing; and the single event analysis and the simulating of the betting markets can be repeatedly executed each time the sports data is periodically received, such that: the single event prediction and the predicted betting markets are periodically updated; and the user interface is periodically updated upon receiving one or more of an updated single event prediction and an update of the predicted betting markets.

In some configurations, the single event prediction can include a cumulative probability of a plurality of events occurring within the single sporting event.

In some configurations, the simulated market participant data model can identify historical behaviors of a plurality of users, resulting in at least one correlation; and the simulated markets model can utilize the at least one correlation to predict how the plurality of users will reach under a predetermined condition. In such configurations, the illustrated method can further include: ranking, via the at least one processor, a plurality of betting options based on the single event prediction, the predicted betting markets, a projected upside, resulting in a ranked list of betting options; identifying, via the at least one processor, a number of top ranked bets within the ranked list of betting options; and presenting, via the user interface, the number of top ranked bets to a user. Moreover, such a method can include: receiving, from the user: a simulation weight; a projection weight; an upside weight; and a correlation weight, wherein: the simulation weight modifies how the single event prediction is ranked; the projection weight modifies how the predicted betting markets are ranked; the upside weight modifies how a projected upside is ranked; and the correlation weight modifies how the at least one correlation effects the simulated markets model.

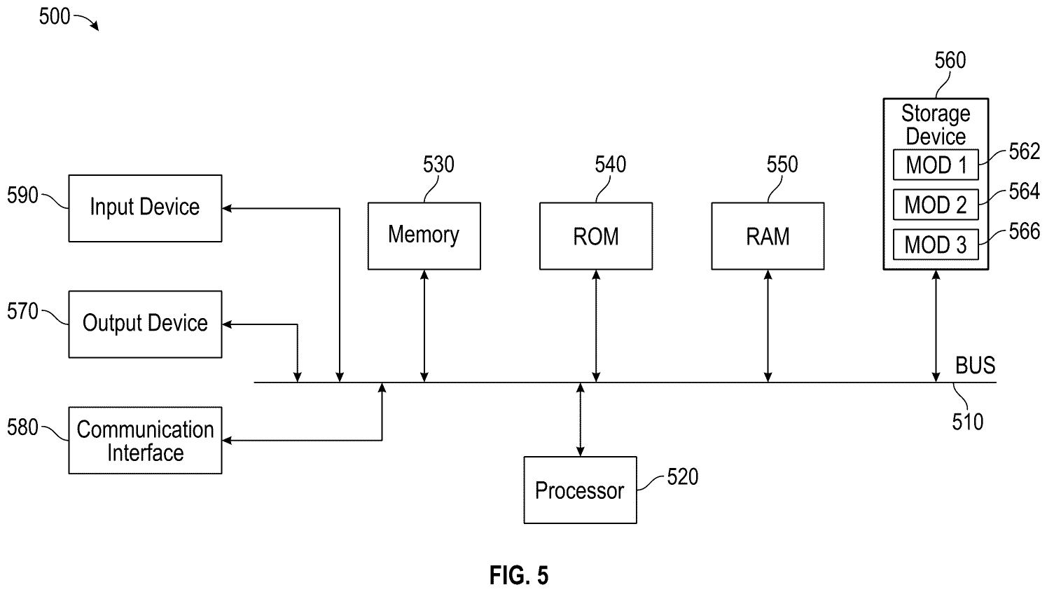

With reference to FIG. 5, an exemplary system includes a general-purpose computing device 500, including a processing unit (CPU or processor) 520 and a system bus 510 that couples various system components including the system memory 530 such as read-only memory (ROM) 540 and random-access memory (RAM) 550 to the processor 520. The system 500 can include a cache of high-speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general-purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per sc.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, from a user at a computer system, a selection of an event; generating, via at least one processor of the computer system, a plurality of simulations of the event, resulting in a plurality of simulation results; receiving, from at least one digital marketplace, a plurality of bets, each bet of the plurality of bets corresponding to a simulation result in the plurality of simulation results; displaying the plurality of bets, resulting in displayed bets; receiving, from the user, a first selection from the plurality of bets; filtering, via the at least one processor, the plurality of bets based on the first selection, resulting in filtered bets; displaying the filtered bets; receiving, from the user, a second selection from the filtered bets; and receiving confirmation of the first selection and the second selection from the user.

A method comprising: receiving, at a computer system, sports data; generating, by executing a predictive event outcomes model using at least one processor of the computer system, simulated events data, wherein input to the predictive event outcomes model comprises the sports data; executing, via the at least one processor, a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

The method of any preceding clause, wherein computer system is a cloud computing system.

The method of any preceding clause, wherein: the sports data is periodically received while the single sporting event is ongoing; and the single event analysis and the simulating of the betting markets are repeatedly executed each time the sports data is periodically received, such that: the single event prediction and the predicted betting markets are periodically updated; and the user interface is periodically updated upon receiving one or more of an updated single event prediction and an update of the predicted betting markets.

The method of any preceding clause, wherein the single event prediction comprises a cumulative probability of a plurality of events occurring within the single sporting event.

The method of any preceding clause, wherein: the simulated market participant data model identifies historical behaviors of a plurality of users, resulting in at least one correlation; and the simulated markets model utilizes the at least one correlation to predict how the plurality of users will reach under a predetermined condition.

The method of any preceding clause, further comprising: ranking, via the at least one processor, a plurality of betting options based on the single event prediction, the predicted betting markets, a projected upside, resulting in a ranked list of betting options; identifying, via the at least one processor, a number of top ranked bets within the ranked list of betting options; and presenting, via the user interface, the number of top ranked bets to a user.

The method of any preceding clause, further comprising: receiving, from the user: a simulation weight; a projection weight; an upside weight; and a correlation weight, wherein: the simulation weight modifies how the single event prediction is ranked; the projection weight modifies how the predicted betting markets are ranked; the upside weight modifies how a projected upside is ranked; and the correlation weight modifies how the at least one correlation effects the simulated markets model.

A system comprising: at least one processor; and a non-tangible computer-readable storage medium having instructions stored which, when executed by the at least one processor, cause the at least one processor to perform operations comprising: receiving sports data; generating, by executing a predictive event outcomes model, simulated events data, wherein input to the predictive event outcomes model comprises the sports data; executing a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

The system of any preceding clause, wherein computer system is a cloud computing system.

The system of any preceding clause, wherein: the sports data is periodically received while the single sporting event is ongoing; and the single event analysis and the simulating of the betting markets are repeatedly executed each time the sports data is periodically received, such that: the single event prediction and the predicted betting markets are periodically updated; and the user interface is periodically updated upon receiving one or more of an updated single event prediction and an update of the predicted betting markets.

The system of any preceding clause, wherein the single event prediction comprises a cumulative probability of a plurality of events occurring within the single sporting event.

The system of any preceding clause, wherein: the simulated market participant data model identifies historical behaviors of a plurality of users, resulting in at least one correlation; and the simulated markets model utilizes the at least one correlation to predict how the plurality of users will reach under a predetermined condition.

The system of any preceding clause, the non-tangible computer-readable storage medium having additional instructions stored which, when executed by the at least one processor, cause the at least one processor to perform operations comprising: ranking, via the at least one processor, a plurality of betting options based on the single event prediction, the predicted betting markets, a projected upside, resulting in a ranked list of betting options; identifying, via the at least one processor, a number of top ranked bets within the ranked list of betting options; and presenting, via the user interface, the number of top ranked bets to a user.

The system of any preceding clause, the non-tangible computer-readable storage medium having additional instructions stored which, when executed by the at least one processor, cause the at least one processor to perform operations comprising: receiving, from the user: a simulation weight; a projection weight; an upside weight; and a correlation weight, wherein: the simulation weight modifies how the single event prediction is ranked; the projection weight modifies how the predicted betting markets are ranked; the upside weight modifies how a projected upside is ranked; and the correlation weight modifies how the at least one correlation effects the simulated markets model.

A non-tangible computer-readable storage medium having instructions stored which, when executed by at least one processor, cause the at least one processor to perform operations comprising: receiving sports data; generating, by executing a predictive event outcomes model, simulated events data, wherein input to the predictive event outcomes model comprises the sports data; executing a simulated market participant data model, resulting in a simulated markets model, wherein inputs to the simulated market participant data model comprises the sports data and the simulated events data; executing, via the at least one processor using the simulated events data associated with a single sporting event, a single event analysis, resulting in a single event prediction; simulating, via the at least one processor executing the simulated markets model, betting markets for the single sporting event, resulting in predicted betting markets, wherein the executing of the single event analysis and the simulating of the betting markets occur in parallel; and outputting, to a user interface from the computer system, the single event prediction and the predicted betting markets.

The non-tangible computer-readable storage medium of any preceding clause, wherein computer system is a cloud computing system.

The non-tangible computer-readable storage medium of any preceding clause, wherein: the sports data is periodically received while the single sporting event is ongoing; and the single event analysis and the simulating of the betting markets are repeatedly executed each time the sports data is periodically received, such that: the single event prediction and the predicted betting markets are periodically updated; and the user interface is periodically updated upon receiving one or more of an updated single event prediction and an update of the predicted betting markets.

The non-tangible computer-readable storage medium of any preceding clause, wherein the single event prediction comprises a cumulative probability of a plurality of events occurring within the single sporting event.

The non-tangible computer-readable storage medium of any preceding clause, wherein: the simulated market participant data model identifies historical behaviors of a plurality of users, resulting in at least one correlation; and the simulated markets model utilizes the at least one correlation to predict how the plurality of users will reach under a predetermined condition.

The non-tangible computer-readable storage medium of any preceding clause, the non-tangible computer-readable storage medium having additional instructions stored which, when executed by the at least one processor, cause the at least one processor to perform operations comprising: ranking, via the at least one processor, a plurality of betting options based on the single event prediction, the predicted betting markets, a projected upside, resulting in a ranked list of betting options; identifying, via the at least one processor, a number of top ranked bets within the ranked list of betting options; and presenting, via the user interface, the number of top ranked bets to a user.

We claim:

1. A method comprising:
receiving, at a computer system, sports data;
generating, by executing a predictive event outcomes model using at least one processor of the computer system, simulated events data, wherein input to the predictive event outcomes model comprises the sports data;
executing, via the at least one processor, a simulated market participant data model, resulting in a simulated markets model, wherein inputs to the simulated market participant data model comprises the sports data and the simulated events data;
executing, via the at least one processor using the simulated events data associated with a single sporting event, a single event analysis, resulting in a single event prediction;
simulating, via the at least one processor executing the simulated markets model, betting markets for the single sporting event, resulting in predicted betting markets,
wherein the executing of the single event analysis and the simulating of the betting markets occur in parallel; and
outputting, to a user interface from the computer system, the single event prediction and the predicted betting markets.

2. The method of claim 1, wherein computer system is a cloud computing system.

3. The method of claim 2, wherein:
the sports data is periodically received while the single sporting event is ongoing; and
the single event analysis and the simulating of the betting markets are repeatedly executed each time the sports data is periodically received,
such that:
the single event prediction and the predicted betting markets are periodically updated; and
the user interface is periodically updated upon receiving one or more of an updated single event prediction and an update of the predicted betting markets.

4. The method of claim 1, wherein the single event prediction comprises a cumulative probability of a plurality of events occurring within the single sporting event.

5. The method of claim 1, wherein:
the simulated market participant data model identifies historical behaviors of a plurality of users, resulting in at least one correlation; and
the simulated markets model utilizes the at least one correlation to predict how the plurality of users will reach under a predetermined condition.

6. The method of claim 5, further comprising:
ranking, via the at least one processor, a plurality of betting options based on the single event prediction, the predicted betting markets, a projected upside, resulting in a ranked list of betting options;
identifying, via the at least one processor, a number of top ranked bets within the ranked list of betting options; and
presenting, via the user interface, the number of top ranked bets to a user.

7. The method of claim 6, further comprising:
receiving, from the user:
a simulation weight;
a projection weight;
an upside weight; and
a correlation weight,
wherein:
the simulation weight modifies how the single event prediction is ranked;
the projection weight modifies how the predicted betting markets are ranked;
the upside weight modifies how a projected upside is ranked; and
the correlation weight modifies how the at least one correlation effects the simulated markets model.

8. A system comprising:
at least one processor; and
a non-tangible computer-readable storage medium having instructions stored which, when executed by the at least one processor, cause the at least one processor to perform operations comprising:
receiving sports data;
generating, by executing a predictive event outcomes model, simulated events data, wherein input to the predictive event outcomes model comprises the sports data;
executing a simulated market participant data model, resulting in a simulated markets model, wherein inputs to the simulated market participant data model comprises the sports data and the simulated events data;
executing, via the at least one processor using the simulated events data associated with a single sporting event, a single event analysis, resulting in a single event prediction;
simulating, via the at least one processor executing the simulated markets model, betting markets for the single sporting event, resulting in predicted betting markets,
wherein the executing of the single event analysis and the simulating of the betting markets occur in parallel; and
outputting, to a user interface from the computer system, the single event prediction and the predicted betting markets.

9. The system of claim 8, wherein computer system is a cloud computing system.

10. The system of claim 9, wherein:
the sports data is periodically received while the single sporting event is ongoing; and
the single event analysis and the simulating of the betting markets are repeatedly executed each time the sports data is periodically received,
such that:
the single event prediction and the predicted betting markets are periodically updated; and
the user interface is periodically updated upon receiving one or more of an updated single event prediction and an update of the predicted betting markets.

11. The system of claim 8, wherein the single event prediction comprises a cumulative probability of a plurality of events occurring within the single sporting event.

12. The system of claim 8, wherein:
the simulated market participant data model identifies historical behaviors of a plurality of users, resulting in at least one correlation; and
the simulated markets model utilizes the at least one correlation to predict how the plurality of users will reach under a predetermined condition.

13. The system of claim 12, the non-tangible computer-readable storage medium having additional instructions stored which, when executed by the at least one processor, cause the at least one processor to perform operations comprising:
ranking, via the at least one processor, a plurality of betting options based on the single event prediction, the predicted betting markets, a projected upside, resulting in a ranked list of betting options;
identifying, via the at least one processor, a number of top ranked bets within the ranked list of betting options; and
presenting, via the user interface, the number of top ranked bets to a user.

14. The system of claim 13, the non-tangible computer-readable storage medium having additional instructions stored which, when executed by the at least one processor, cause the at least one processor to perform operations comprising:
receiving, from the user:
a simulation weight;
a projection weight;
an upside weight; and
a correlation weight,
wherein:
the simulation weight modifies how the single event prediction is ranked;
the projection weight modifies how the predicted betting markets are ranked;
the upside weight modifies how a projected upside is ranked; and
the correlation weight modifies how the at least one correlation effects the simulated markets model.

15. A non-tangible computer-readable storage medium having instructions stored which, when executed by at least one processor, cause the at least one processor to perform operations comprising:
receiving sports data;
generating, by executing a predictive event outcomes model, simulated events data, wherein input to the predictive event outcomes model comprises the sports data;
executing a simulated market participant data model, resulting in a simulated markets model, wherein inputs to the simulated market participant data model comprises the sports data and the simulated events data;
executing, via the at least one processor using the simulated events data associated with a single sporting event, a single event analysis, resulting in a single event prediction;
simulating, via the at least one processor executing the simulated markets model, betting markets for the single sporting event, resulting in predicted betting markets,
wherein the executing of the single event analysis and the simulating of the betting markets occur in parallel; and
outputting, to a user interface from the computer system, the single event prediction and the predicted betting markets.

16. The non-tangible computer-readable storage medium of claim 15, wherein computer system is a cloud computing system.

17. The non-tangible computer-readable storage medium of claim 16, wherein:
the sports data is periodically received while the single sporting event is ongoing; and
the single event analysis and the simulating of the betting markets are repeatedly executed each time the sports data is periodically received,
such that:
the single event prediction and the predicted betting markets are periodically updated; and
the user interface is periodically updated upon receiving one or more of an updated single event prediction and an update of the predicted betting markets.

18. The non-tangible computer-readable storage medium of claim 15, wherein the single event prediction comprises a cumulative probability of a plurality of events occurring within the single sporting event.

19. The non-tangible computer-readable storage medium of claim 15, wherein:
the simulated market participant data model identifies historical behaviors of a plurality of users, resulting in at least one correlation; and
the simulated markets model utilizes the at least one correlation to predict how the plurality of users will reach under a predetermined condition.

20. The non-tangible computer-readable storage medium of claim 19, the non-tangible computer-readable storage medium having additional instructions stored which, when executed by the at least one processor, cause the at least one processor to perform operations comprising:
ranking, via the at least one processor, a plurality of betting options based on the single event prediction, the predicted betting markets, a projected upside, resulting in a ranked list of betting options;
identifying, via the at least one processor, a number of top ranked bets within the ranked list of betting options; and
presenting, via the user interface, the number of top ranked bets to a user.
